(19) United States
(12) Patent Application Publication
(10) Pub. No.: US 2020/0042150 A1
(43) Pub. Date: Feb. 6, 2020

(54) Method for Determining Working Mode, Touch Device and Readable Storage Medium

(71) Applicant: AAC ACOUSTIC TECHNOLOGIES (SHENZHEN) CO., LTD., Shenzhen (CN)

(72) Inventors: Yao Wang, Shenzhen (CN); Jiaying Gu, Shenzhen (CN)

(21) Appl. No.: 16/524,060

(22) Filed: Jul. 27, 2019

(30) Foreign Application Priority Data
Aug. 2, 2018 (CN) 201810870128.1

(51) Int. Cl. G06F 3/0488; G06F 3/0484; G06F 3/041

(52) U.S. Cl. CPC G06F 3/0488; G06K 9/00087; G06F 3/041; G06F 3/0484

(57) ABSTRACT

The present invention provides a method for determining a working mode, including steps of: obtaining an application information of a touch device; determine a working mode corresponding to the application information of the touch device, wherein, the working mode includes information of a display module of the touch device and/or information of a touch module of the touch device.

### FIELD OF THE PRESENT DISCLOSURE

The embodiments of the invention relate to the electronic information technical field, in particular to a method for determining a working mode, a touch device and a readable storage medium.

### DESCRIPTION OF RELATED ART

As the human-computer interaction devices, touch devices are widely used in various electronic products, such as smart phones, tablets, etc. In the process of use, the touch devices acquire and display information according to the working modes as set.

However, the inventor of the invention finds that there is only one working mode set in the touch devices, which results in the single working mode and poor flexibility of the touch devices.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is a flowchart of a method for determining a working mode in a first embodiment of the invention.

FIG. 2 is a flowchart of a method for determining a working mode in a second embodiment of the invention.

FIG. 3 is a structural diagram of a touch device according to a third embodiment of the invention.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiment described hereby are only to explain the disclosure, not intended to limit the disclosure.

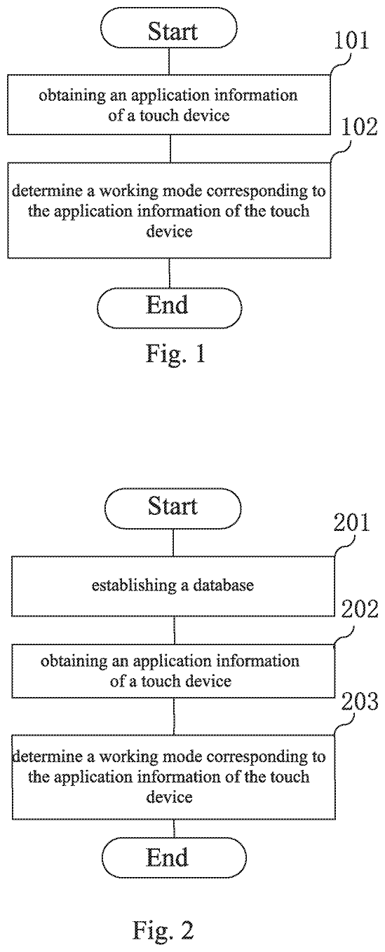

The first embodiment of the invention relates to a method for determining a working mode, which is applied to a touch device. The specific flowchart is shown in FIG. 1, including the following steps:

Step 101: acquire an application information of the touch device.

Specifically, the application information of the touch device can be one or any combination of the information of the device connected with the touch device, the user information of the touch device, the communication mode of the touch device and the environmental information of the touch device, or the instruction information of the switch mode input by the user. Among them, the communication mode of the touch device can be infrared communication, Bluetooth communication or wireless-Fidelity (WiFi) communication. According to the current communication mode of the touch device, the working mode corresponding to the communication mode is determined by the touch device.

Step 102: determine a working mode corresponding to the application information of the touch device according to the application information of the touch device.

Specifically, the working mode includes the information of the display module of the touch device and/or the information of the touch module of the touch device. The information of the display module of the touch device includes the symbol system scheme, color style scheme, page layout scheme, etc., of the touch device. The information of the touch module of the touch device includes the touch input scheme and the tactile feedback scheme. Among them, the touch input scheme can be finger/tool pressing, gesture recognition, etc. The tactile feedback scheme can be strong vibration feedback, weak vibration feedback, voice feedback, etc.

It is worth mentioning that the touch device uses different display modules for different devices, which makes the display and distribution of the buttons of the touch device be more flexible.

It shall be noted that after determining the working mode corresponding to the application information of the touch device, the touch device can directly switch to the corresponding working mode, or ask the user if the user needs to determine whether to switch the working mode after switching. The embodiment does not limit the specific realization of the touch device to switch the working mode.

It is worth mentioning that the touch device can store the information of the touch module and the information of the display module one by one in the touch device, which solves the separation of the information of the touch module and the information of the display module and enables the touch device to switch the touch module and the display module at the same time.

Examples are given below to illustrate the method of determining the working mode of the touch device according to the application information of different touch devices.

Case 1: the application information of the touch device is the information of the device connected with the touch device. According to the application information of the touch device, the touch device judges whether the device connected with the touch device has changed or not. If yes, the working mode of the touch device is switched to the corresponding working mode of the device currently connected to the touch device according to the information of the device currently connected with the touch device

For example, when the touch device is a smart home remote controller which stores the first working mode and the second working mode. The smart home remote controller obtains the name of the device connected with the smart home remote controller. If the name of the device is determined to be the name of the TV, then the currently-connected device is determined to be the TV, and the working mode is switched to the first working mode. Wherein, the operation interface scheme in the display module of the first working mode is the first operation interface scheme, the touch input scheme of the touch module is press recognition, and the touch feedback scheme is vibration feedback. In the first operation interface scheme, the layout of the operation interface is similar to that of the traditional TV remote controller. If the smart home remote controller determines that the name of the device is the name of the computer, it determines that the currently-connected device is the computer, and the working mode is switched to the second working mode, wherein, the operation interface scheme in the display module of the second working mode is the second operation interface scheme, the touch input scheme in the touch module is press recognition, and the touch feedback scheme is gesture recognition and vibration feedback. In the second operation interface scheme, the layout of the operation interface is similar to that of the traditional keyboard. The gesture recognition of the smart home remote controller is to identify the user's gesture and determine the moving direction of the mouse cursor.

For another example, the touch device is located in a car and installed on the worktop of the car. The touch device is connected with the worktop, the vehicle entertainment system, the navigation system, etc., of the car. The touch device determines the brightness value in the display module of the touch device according to the system currently connected. When the touch device is connected with the vehicle entertainment system, the brightness value of the display module of the touch device is low to reduce the power consumption of the touch device. When the touch device is connected with the navigation system, the brightness value of the display module of the touch device is high, so that the user can see the navigation map clearly.

It is worth mentioning that the touch device can switch the working mode when connect with different devices, which improves the intelligence level of the touch device.

Case 2: the application information of the touch device is the user information of the touch device. The touch device obtains the user's identity information, wherein, the identity information can be one or any combination of fingerprint information, face recognition information and voiceprint information. The touch device determines the user's information of the touch device according to the user's identity information. After determining the user's information, the touch device switches the working mode to the corresponding working mode of the user, for example, the touch device is a virtual keyboard which can switch the display layout (such as language, font size) or display style of the virtual keyboard according to the current user, as well as the feedback mode when the keys are pressed, such as vibration feedback and sound feedback. For example, when the virtual keyboard determines that the current user is the first user, it determines that the font of the virtual keyboard is the small four-size font. When the virtual keyboard determines that the current user is the second user, it determines that the font of the virtual keyboard is the three-size font, so that the second user can see clearly the content displayed by the virtual keyboard.

It is worth mentioning that the touch device can provide different working modes for different users, which further improves the intelligence of the touch device.

Case 3: the application information of the touch device is the environmental information of the touch device. The touch device obtains the data transmitted by the detector, and determines the environmental information of the touch device according to the data transmitted by the detector. According to the environmental information, the touch device switches to the working mode corresponding to the environment, wherein, the detector is used to detect the environmental information around the touch device, which can be one or any combination of the temperature sensor, humidity sensor, sound sensor and brightness sensor, for example, the touch device is located in the car and installed on the worktop of the car. According to the data detected by the detector, the touch device determines the environmental information such as brightness, noise, etc., in the car, and switches the working mode according to the environmental information.

It is worth mentioning that the touch device uses different working modes in different environments, which improves the intelligence of the touch device.

It needs to explain that the embodiment takes the simultaneous switching of the display module and touch module of the touch device as the example. In practical application, the touch device can also only switch the display module or touch module. The specific switching process can refer to the description of simultaneously switching the display module and touch module in the embodiment.

It needs to explain that in the embodiment, the display screen of the touch device can be either a flat screen or a curve screen, such as a spherical surface.

Compared with the prior art, the touch device can determine the use occasion of the touch device according to the application information of the touch device. The touch device can determine the working mode of the touch device according to the use occasion of the touch device, which enables the touch device to switch between different working modes, improves the flexibility of the touch device and improves the user experience.

The second embodiment of the invention relates to a method for determining the working mode. The embodiment is roughly the same as the first embodiment. The main difference is that other relevant steps are added before step 101.

As shown in FIG. 2, the embodiment includes step 201 to step 203, wherein, step 202 and step 203 are roughly the same as step 101 and step 102 in the first embodiment respectively, and not detailed here. The differences are mainly described below:

Step 201: establish a database.

Specifically, a database is established in the touch device, and stores the application information of the touch device and the corresponding relationship between the working modes of the touch device. After acquiring the current application information of the touch device, the touch device judges whether there is any known application information matching the current application information in the database; if yes, the working mode corresponding to the current application information of the touch device is determined, and the corresponding working mode is switched; otherwise, the user is reminded that new application information is detected or it is switched to the default working mode.

It needs to explain that the database in the touch device can be the official database imported by the manufacturer when the touch device is delivered. There are some common working modes in the official database and the known application information corresponding to the working modes. The database of the touch device can also be a personal database established after determining the corresponding relationship between the application information of the touch device contained in the information and the working mode of the touch device according to the information input by the user, namely, the corresponding relationship between the application information of the touch device and the working mode of the touch device can be customized by the user.

An example is given below to describe the method of the corresponding relationship between the application information of the touch device customized by the user and the working mode of the touch device.

Method 1, the touch device generates the corresponding relationship between the application information of the touch device and the working mode of the touch device according to the application information input by the user in the touch device and the corresponding working mode of the application information.

Method 2, after obtaining the application information input by the user in the touch device, the touch device recommends the working mode of the touch device corresponding to the application information similar to the application information of the touch device for the user. The user can directly select the recommended working mode as the working mode corresponding to the application information input by the user in the touch device.

Method 3, after the user chooses one of the existing working modes, the user adds new application information under the working mode. According to the working mode selected by the user and the new application information, the touch device determines the corresponding relationship between the new application information and the working mode of the touch device.

It needs to explain that in practical application, the corresponding relationship between the application information of the touch device and the working mode of the touch device can be modified according to the user's input instruction.

It needs to explain that in order to clarify the embodiment, step 201 is taken as the previous step of step 202. In practical application, the touch device can execute step 201 after step 202. The embodiment does not restrict the execution sequence of step 201 and step 202.

Compared with the prior art, the touch device can determine the use occasion of the touch device according to the application information of the touch device. Because the touch device can determine the working mode according to the use occasion of the touch device, the touch device can switch between different working modes, which improves the flexibility of the touch device and the user experience. In addition, the user can customize the corresponding relationship between the application information of the touch device and the working mode of the touch device, which further improves the user experience.

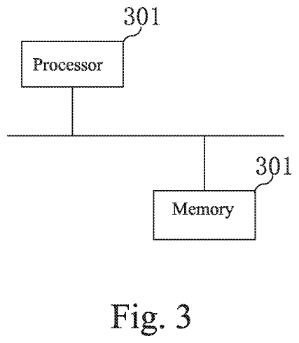

The third embodiment of the invention relates to an electronic device of which the structure is shown in FIG. 3, including: at least one processor 301; and a memory 302 communicating with the processor 301, wherein, the memory 302 stores instructions that can be executed by the processor 301. The instructions are executed by the processor 301 to make the processor 301 execute the method mentioned in the above embodiment to determine the working mode.

In the embodiment, the processor 301 and the memory 302 can be connected by buses or other means, as shown in FIG. 3. As a non-volatile computer readable storage medium, the memory 302 can be used to store non-volatile software programs, non-volatile computer executable programs and modules. For example, the corresponding relationship between the application information of the touch device and the working mode of the touch device in the embodiment of the invention is stored in the memory 302. The processor 301 executes all functional applications and data processing of the device by running the non-volatile software programs, instructions and modules stored in the memory 302, namely, the method for determining the working mode described above is realized.

The memory 302 may include a program storage area and a data storage area, wherein, the program storage area may store the operation system and the application required by at least one function, and the data storage area can store an option list, etc. In addition, the memory 302 may include a high-speed random access memory and a non-volatile memory, such as at least one disk memory device, a flash memory device, or other non-volatile solid-state memory devices. In some embodiments, the memory 302 may optionally include the memories which are set remotely relative to the processor. These remote memories can be connected to an external device via a network. The examples of the above networks include but are not limited to the Internet, intranet, local area network, mobile communication network and their combinations.

One or more modules are stored in the memory, and when executed by one or more processors, the modules execute the method for determining the working mode in any of the embodiments of the above-mentioned methods.

The above-mentioned products can execute the methods provided by the embodiments of the invention, and have the corresponding functional modules and beneficial effects of the execution methods. The technical details not described in detail in the embodiments can be referred to the methods provided by the embodiments of the invention.

The fourth embodiment of the invention relates to a computer readable storage medium that stores a computer program. When executed by the processor, the computer program can realize the method for determining the working mode mentioned in the first embodiment or the second embodiment.

The technicians in the field can understand that all or part of the steps for realizing the above-mentioned embodiments can be accomplished by directing the relevant hardware through a program stored in a storage medium, including all or part of the steps used by several instructions for making a device (such as a single chip computer, a chip, etc.) or a processor to execute the methods described in all embodiments of the invention. The above-mentioned storage media include: U disk, mobile hard disk, Read-Only Memory (ROM), Random Access Memory (RAM), a disk or CD-ROM, which can store program codes.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A method for determining a working mode, including steps of:
obtaining an application information of a touch device;
determine a working mode corresponding to the application information of the touch device, wherein, the working mode includes information of a display module of the touch device and/or information of a touch module of the touch device.

2. The method for determining a working mode as described in claim 1, wherein the application information of the touch device includes one or any combination of the information of the device connected with the touch device, the information of the user of the touch device, the communication mode of the touch device and the environmental information of the touch device.

3. The method for determining a working mode as described in claim 1, wherein the application information of the touch device is an instruction information input by a user to switch the working mode.

4. The method for determining a working mode as described in claim 3, wherein the application information of the touch device is information of the user of the touch device, and wherein the step of acquiring the application information of the touch device includes steps of:
obtaining the user's identity information, wherein, the identity information includes one or any combination of fingerprint information, face recognition information and voiceprint information;
determining the user's information of the touch device according to the user's identity information.

5. The method for determining a working mode as described in claim 2, wherein the application information of the touch device is the environmental information of the touch device, and wherein the step of acquiring the application information of the touch device includes steps of:
obtaining data transmitted by the detector, wherein, the detector is used for detecting the environmental information around the touch device;
according to the data transmitted by the detector, the environmental information of the touch device is determined.

6. The method for determining a working mode as described in claim 5, wherein the detector includes one or any combination of temperature sensor, humidity sensor, sound sensor and brightness sensor.

7. The method for determining a working mode as described in claim 2, wherein that the application information of the touch device includes the information of the device connected with the touch device, and wherein the step of determining the working mode corresponding to the application information of the touch device includes:
judging whether the device connected with the touch device changes according to the information of the device connected with the touch device;
if yes, the working mode of the touch device is switched to the working mode corresponding to the device currently connected to the touch device.

8. The method for determining a working mode as described in claim 1, wherein before the working mode corresponding to the application information of the touch device is determined, the step for determining the working mode also includes:
establishing a database, wherein, the database stores the corresponding relationship between the application information of the touch device and the working mode of the touch device.

9. A touch device including:
at least one processor; and
a memory communicating with the processor; wherein,
the memory stores instructions that can be executed by the processor to execute the method for determining the working mode as described in claim 1.

10. A computer readable storage medium that stores a computer program, wherein the method for determining the working mode as described in claim 1 is performed when the computer program is executed by the processor.
